(19) United States
(12) Patent Application Publication
(10) Pub. No.: US 2022/0170613 A1
(43) Pub. Date: Jun. 2, 2022

(54) OPTICAL ELEMENT, VEHICLE HEADLIGHT, LIGHT SOURCE DEVICE, AND PROJECTION DEVICE

(71) Applicant: SHARP KABUSHIKI KAISHA, Sakai City, Osaka (JP)

(72) Inventors: TOMOKO UEKI, Sakai City, Osaka (JP); SHIGERU AOMORI, Sakai City, Osaka (JP); HIDETSUGU MATSUKIYO, Sakai City, Osaka (JP)

(21) Appl. No.: 17/439,766

(22) PCT Filed: Mar. 10, 2020
(86) PCT No.: PCT/JP2020/010256

§ 371 Date: Sep. 15, 2021

(30) Foreign Application Priority Data
Mar. 19, 2019 (JP) 2019-051276

(51) Int. Cl. F21V 9/32; F28F 21/00

(52) U.S. Cl. CPC F21V 9/32; F21S 45/47; F28F 21/00

(57) ABSTRACT

An optical element includes: a phosphor layer excited by excitation light emitted from a light source, and emitting fluorescence; a translucent thermal-conductive layer formed on a face of the phosphor layer that is irradiated with the excitation light; and a non-translucent thermal-conductive layer formed on a face of the phosphor layer that is across from the face irradiated with the excitation light. The translucent thermal-conductive layer has a thermal conductivity higher than, or equal to, a thermal conductivity of the phosphor layer.

### TECHNICAL FIELD

The disclosure relates to an optical element, a vehicle headlight, a light source device, and a projection device.

The present application claims priority from Japanese Application JP2019-051276 filed on Mar. 19, 2019, the content of which is hereby incorporated by reference into this application.

### BACKGROUND ART

A technique often used for light-emitting apparatuses involves emitting such excitation light as laser light to a phosphor layer containing a phosphor, and exiting the phosphor to emit fluorescence. A problem of the light-emitting apparatuses utilizing such a technique is that the emitted laser light raises the temperature of the phosphor layer, causing a decrease in efficiency of the fluorescence emission.

Patent Document 1, for example, discloses a light-emitting apparatus moving a phosphor layer and changing a position of the phosphor layer irradiated with excitation light, thereby curbing a rise in temperature of the phosphor.

Moreover, Patent Document 2 discloses that a thickness of a phosphor layer is reduced in a position irradiated with a center of excitation light; that is, a position where the temperature is most likely to rise. Utilizing such a configuration, Patent Document 2 discloses a light source device in which the heat resistance of the phosphor layer decreases and the heat of the phosphor layer is likely to dissipate, thereby curbing a rise in the temperature of the phosphor layer.

Furthermore, Patent Document 3 discloses a translucent heat-dissipation layer formed on each face of a phosphor layer. Hence, the heat generated in the phosphor layer is efficiently dissipated outside from the translucent heat-dissipation layer formed on each face of the phosphor layer. Utilizing such a configuration, Patent Document 3 discloses a wavelength conversion member curbing a rise in temperature of the phosphor layer, thereby curbing a temporal decrease in intensity of emitted light.

### CITATION LIST

### Patent Literature

Patent Document 1: Japanese Unexamined Patent Application Publication No. 2010-086815 (published on Apr. 15, 2010)
Patent Document 2: Japanese Unexamined Patent Application Publication No. 2016-018110 (published on Feb. 1, 2016)
Patent Document 3: Japanese Unexamined Patent Application Publication No. 2016-027613 (published on Feb. 18, 2016)

### SUMMARY OF DISCLOSURE

### Technical Problems

The light-emitting apparatus disclosed in Patent Document 1 has to include a drive system to move the phosphor layer, making it difficult to reduce the size of the light-emitting apparatus. Moreover, the drive system would inevitably increase power consumption and vibration noise.

Moreover, the light source device disclosed in Patent Document 2 has less phosphor irradiated with the excitation light, causing a problem of a decrease in intensity of emitted light.

Furthermore, the wavelength conversion member disclosed in Patent Document 3 cannot sufficiently curb the temperature rise of the phosphor layer.

Hence, an aspect of the disclosure is intended to provide an optical element curbing a rise in temperature caused by emitted excitation light, and curbing a decrease in efficiency of light emission.

### Solution to Problems

In order to solve the above problems, an optical element according to an aspect of the disclosure includes:

a phosphor layer excited by excitation light emitted from a light source, and emitting fluorescence;

a translucent thermal-conductive layer formed on a face, of the phosphor layer, irradiated with the excitation light; and

a non-translucent thermal-conductive layer formed on a face, of the phosphor layer, across from the face irradiated with the excitation light.

The translucent thermal-conductive layer has a thermal conductivity higher than, or equal to, a thermal conductivity of the phosphor layer.

### Advantageous Effect of Disclosure

An aspect of the disclosure achieves an advantageous effect to provide an optical element curbing a temperature rise due to emission of excitation light and a decrease in efficiency of fluorescence emission.

### BRIEF DESCRIPTION OF DRAWINGS

FIG. 1(A) is a schematic view illustrating how excitation light is emitted. FIG. 1(B) is a graph schematically showing a relationship between a density of emitted energy in excitation light and a luminance of the emitted light. FIG. 1(C) shows examples of a luminance distribution of the emitted light (top) and a temperature distribution in a phosphor layer (bottom) in which no luminance saturation is observed (left) and in a phosphor layer in which luminance saturation is observed (right).

FIG. 2 is a schematic cross-sectional view of an optical element in a comparative example.

FIG. 3(A) is a schematic cross-sectional view of an optical element in a first embodiment of the disclosure. FIG. 3(B) is a graph showing a relationship between a position on a surface, of a phosphor layer, irradiated with excitation light and a temperature of the position.

FIG. 4 is a schematic view illustrating exemplary arrangements of layers included in the optical element in the first embodiment of the disclosure.

FIG. 5(A) is a schematic cross-sectional view of an optical element in a second embodiment of the disclosure. FIG. 5(B) is a schematic top view of the optical element in the second embodiment of the disclosure. FIG. 5(C) is a schematic top view of a modification of the optical element in the second embodiment of the disclosure.

FIG. 6 is a schematic cross-sectional view of an optical element in a third embodiment of the disclosure.

FIG. 7 is a schematic cross-sectional view of an optical element in a fourth embodiment of the disclosure.

FIG. 8 is a schematic cross-sectional view of an optical element in a fifth embodiment of the disclosure.

FIG. 9 is a schematic cross-sectional view of an optical element in a sixth embodiment of the disclosure.

FIG. 10 is a schematic cross-sectional view of the optical element according to a modification in the sixth embodiment of the disclosure.

FIG. 11 is a schematic view of a vehicle headlight in a seventh embodiment of the disclosure.

FIG. 12 is a schematic view of a vehicle headlight in an eighth embodiment of the disclosure.

FIG. 13 is a schematic view illustrating a light source device in a ninth embodiment of the disclosure.

FIG. 14 is a schematic view of a fluorescent wheel of the light source device in the ninth embodiment of the disclosure.

FIG. 15 is a schematic view of a projection device in a tenth embodiment of the disclosure.

FIG. 16 is a schematic view of a stacking model used in a simulation of examples.

FIG. 17 is a schematic view of the stacking model used in the simulation of the examples.

FIG. 18(A) is an illustration of a temperature distribution in a phosphor layer, shown by a simulation of the examples. FIG. 18(B) is an illustration of a temperature distribution in the phosphor layer, shown by the simulation of the examples.

FIG. 19(A) is a graph showing a relationship between a film thickness and a temperature of a translucent thermal-conductive layer.

FIG. 19(B) is a table showing measured temperatures calculated in the simulation of the examples.

FIG. 20(A) is a graph showing a relationship between a thermal conductivity and a temperature of the translucent thermal-conductive layer.

FIG. 20(B) is a table showing measured temperatures calculated in the simulation of the examples.

FIG. 21 is an illustration of a temperature distribution in a phosphor layer, shown by a simulation without a translucent thermal-conductive layer 3.

FIG. 22 is an illustration of a temperature distribution in a phosphor layer, shown by a simulation when the translucent thermal-conductive layer 3 is higher in thermal conductivity than the phosphor layer 2.

FIG. 23 is an illustration of a temperature distribution in a phosphor layer, shown by a simulation when the translucent thermal-conductive layer 3 is lower in thermal conductivity than the phosphor layer 2.

### DESCRIPTION OF EMBODIMENTS

An optical element according to an embodiment of the disclosure includes: a phosphor layer excited by excitation light emitted from a light source, and emitting fluorescence; a translucent thermal-conductive layer formed on a face, of the phosphor layer, irradiated with the excitation light; and a non-translucent thermal-conductive layer formed on a face, of the phosphor layer, across from the face irradiated with the excitation light. The translucent thermal-conductive layer has a thermal conductivity higher than, or equal to, a thermal conductivity of the phosphor layer.

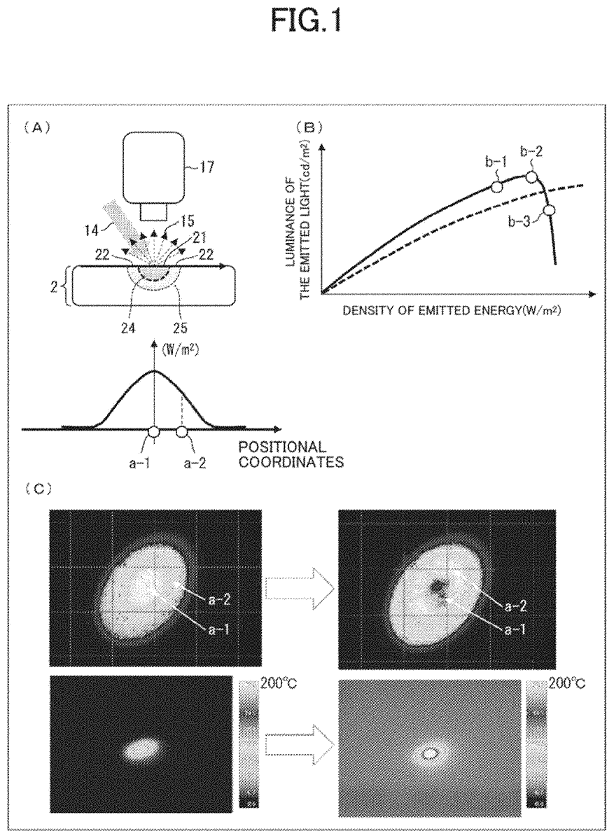

FIG. 1(A) is a schematic view illustrating how the excitation light is emitted. A phosphor layer 2 is irradiated with excitation light 14 to emit fluorescence 15. The graph on the bottom of FIG. 1(A) shows a relationship between a position of a surface, of the phosphor layer 2, irradiated with the excitation light 14 and a density of emitted energy in the excitation light 14. The vertical axis indicates a density of emitted energy (W/m²), and the horizontal axis indicates positional coordinates on the surface of the phosphor layer 2. Coordinate sets a-1 and a-2 respectively correspond to an irradiation center region 21 and an irradiation edge region 22.

In this Description, the “irradiation center region” indicates a surface region, of the phosphor layer 2, within a full width at half maximum (FWHM) of a profile of the emitted energy if the profile of the emitted energy in the excitation light 14 is of the Gaussian distribution. Moreover, the “irradiation edge region” is a surface region, of the phosphor layer 2, within 6σ of the emitted energy in the excitation light 14, indicating a region other than the irradiation center region. If the profile of the emitted energy is not of the Gaussian distribution in such a case as the light source emitting the excitation light 14 includes a lens, the regions are determined with a value of the emitted energy whose profile corresponds to the Gaussian distribution. The above reference to specify the regions is an example, and the regions may be specified with another reference.

As illustrated in FIG. 1(A), the irradiation center region 21 receives higher emitted energy in the excitation light 14, and emits brighter fluorescence 15, than the irradiation edge region 22 does. The high emitted energy tends to raise the temperature of the phosphor layer 2, developing a high temperature region 24 in the irradiation center region 21 of the phosphor layer 2. Meanwhile, the irradiation edge region 22 receives lower emitted energy in the excitation light 14 than the irradiation center region 21 does. Accordingly, the irradiation edge region 22 is a low temperature region 25 lower in temperature than the high temperature region 24. The distribution of the emitted energy in the excitation light 14 is illustrated in the graph of FIG. 1(A).

FIG. 1(B) is a graph schematically showing a relationship between a density of the emitted energy in the excitation light and a luminance of the emitted light. The vertical axis indicates a luminance (cd/m²) of emitted light measured with a luminance meter 17 in FIG. 1(A). Moreover, the temperature of the phosphor layer 2 can be measured with a thermal imager. The horizontal axis indicates a density (W/m²) of emitted energy. The density (W/m²) of emitted energy is a power of the light per unit area. In FIG. 1(B), the solid line indicates a luminance of the irradiation center region 21, and the dashed line indicates a luminance of the irradiation edge region 22.

As illustrated in FIG. 1(B), the higher the density of the emitted energy is, the higher the luminance of the emitted light is. Meanwhile, when the temperature of the phosphor layer rises to a certain temperature or above in response to the rise of the emitted energy, luminance saturation (temperature quenching) is observed and the luminance of the emitted light decreases. In FIG. 1(B), the coordinate set b-1 indicates no luminance saturation observed. The coordinate sets b-2 and b-3 indicate that luminance saturation is observed.

FIG. 1(C) shows exemplary images of a luminance distribution of the emitted light (top) measured with the luminance meter 17 and a temperature distribution (bottom) measured with a thermal imager in a phosphor layer in which no luminance saturation is observed (left) and in a phosphor layer in which luminance saturation is observed (right). In the images (top) showing the luminance distribution of the emitted light, the white portions indicate emission of fluorescence. In the phosphor layer with no luminance saturation observed (left), the irradiation center region 21 (a-1) has a temperature below 200° C. The image shows that the irradiation center region 21 (a-1) with no luminance saturation observed is higher in luminance of the emitted light than the irradiation edge region 22 (a-2). Meanwhile, in the phosphor layer with luminance saturation observed (right), the irradiation center region 21 (a-1) has a temperature of 200° C. or above. The image shows that the irradiation center region 21 (a-1) is lower in luminance of the emitted light than the irradiation edge region 22 (a-2).

### First Embodiment

With reference to FIG. 3, described below is an optical element in a first embodiment of the disclosure. FIG. 3(A) is a schematic cross-sectional view of an optical element 1 in the first embodiment. FIG. 3(B) is a graph showing a relationship between a position on a surface, of a phosphor layer, irradiated with the excitation light 14 and a temperature of the position. The solid line indicates the optical element 1 in the first embodiment, and the dashed line indicates an optical element 11 in a comparative example.

As illustrated in FIG. 3(A), the optical element 1 includes: the phosphor layer 2; a translucent thermal-conductive layer 3; and a non-translucent thermal-conductive layer 4.

The phosphor layer 2 is excited by the excitation light 14 emitted from a light source 13, and emits fluorescence (the emitted fluorescence 15). An example of the light source 13 includes a blue-laser light source emitting the excitation light 14 having a wavelength to excite the phosphor layer.

Phosphor Layer

The phosphor layer 2 contains a phosphor. An example of the phosphor includes a yttrium-aluminium-garnet (YAG, or Y₃Al₅O₁₂):Ce phosphor (a YAG phosphor doped with Ce) excited with a blue-laser light source and emitting fluorescence having a long wavelength range (a yellow wavelength) in visible light. In view of obtaining sufficient fluorescence to be emitted, the phosphor layer 2 has a film thickness of preferably 10 to 150 μm, more preferably 15 to 80 μm, and particularly preferably 20 to 30 μm.

The phosphor layer 2 can be formed of phosphor particles directly coating on the surface of the non-translucent thermal-conductive layer 4, utilizing various techniques such as settling, printing, and transferring.

Translucent Thermal-Conductive Layer

The translucent thermal-conductive layer 3 is formed on a face, of the phosphor layer 2, irradiated with the excitation light 14.

The translucent thermal-conductive layer 3 may be made of a material having a diffusing property. Examples of the material include resin, a glass material, and an inorganic material. The translucent thermal-conductive layer 3 is preferably made of a translucent ceramic material, which excels in thermal conductivity and durability. Examples of the translucent ceramic material include: such oxides as aluminum oxide (alumina), zirconium dioxide, magnesium oxide, titanium oxide, niobium oxide, zinc oxide, and yttrium oxide; such nitrides as boron nitride, and aluminium nitride; and such a carbide as silicon carbide.

The translucent thermal-conductive layer 3 has a thermal conductivity higher than, or equal to, a thermal conductivity of the phosphor layer 2. Such a feature makes it possible to curb a rise in the temperature of the phosphor layer 2 irradiated with the excitation light 14. Specifically, the translucent thermal-conductive layer 3 has a thermal conductivity at 200° C. of preferably 17 W/m·K or higher, more preferably 20 W/m·K or higher, and still more preferably 25 W/m·K or higher.

The translucent thermal-conductive layer 3 has a film thickness of preferably 5 to 100 μm, more preferably 10 to 50 μm, and particularly preferably 15 to 25 μm, in view of reducing a decrease in transmittance of at least one of the excitation light 14 and the emitted fluorescence 15, of curbing a rise in the temperature of the phosphor layer 2, and of enhancing an effect of thermal conductivity.

Non-Translucent Thermal-Conductive Layer

The non-translucent thermal-conductive layer 4 is formed on a face, of the phosphor layer 2, across from the face irradiated with the excitation light 14. The non-translucent thermal-conductive layer 4 is lower in translucency and higher in thermal conductivity than the translucent thermal-conductive layer 3. Specifically, the non-translucent thermal-conductive layer 4 has a thermal conductivity at 200° C. of preferably 50 W/m·K or higher, more preferably 100 W/m·K or higher, and still more preferably 200 W/m·K or higher.

Examples of materials that the non-translucent thermal-conductive layer 4 is made of include: such metals as copper and aluminum; an alloy; and a ceramic material.

When the non-translucent thermal-conductive layer 4 is provided, the heat generated in the phosphor layer 2 irradiated with the excitation light 14 can be released from the non-translucent thermal-conductive layer 4. Consequently, such a feature can curb a rise in the temperature of the high temperature region 24 and a decrease in efficiency of fluorescence emission.

### Comparison with Optical Element in Comparative Example

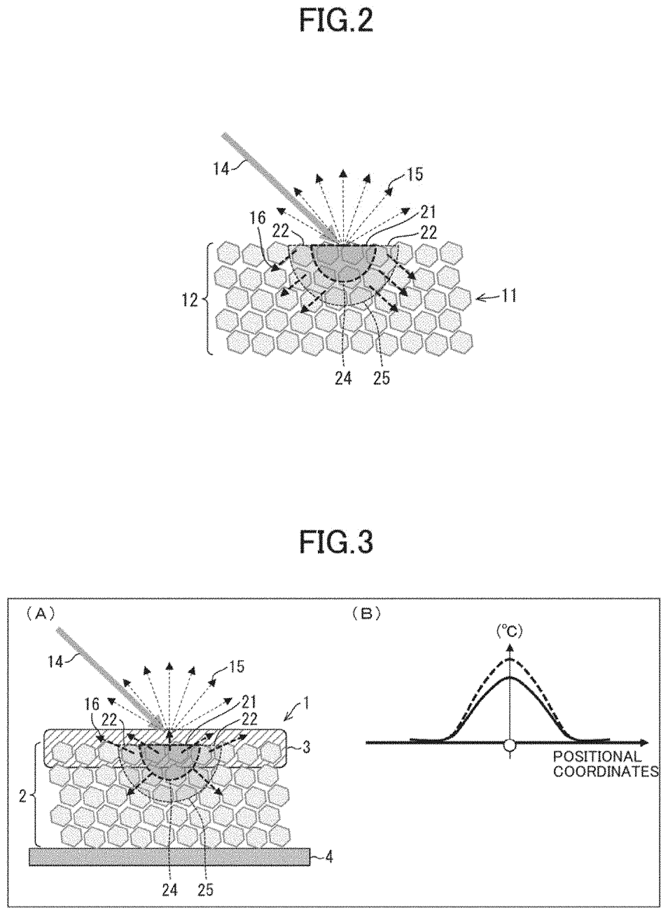

FIG. 2 is a schematic cross-sectional view of the optical element 11 in the comparative example. FIG. 3(B) is a graph showing a relationship between a position on a surface, of the phosphor layer 2 or a phosphor layer 12, irradiated with excitation light 14 and a temperature of the position. The vertical axis indicates a temperature, and the horizontal axis indicates positional coordinates. The origin of the horizontal axis is the irradiation center region 21.

As illustrated in FIG. 2, the optical element 11 includes the phosphor layer 12 alone, and does not include a thermal conductive layer. The phosphor contained in the phosphor layer is higher in thermal conductivity (W/m·K) than the air. Hence, the heat, generated on the surface of the phosphor layer 12 irradiated with the excitation light 14, transfers not to an air layer but to the phosphor layer 12. Moreover, as shown in FIG. 3(B), the temperature of the low temperature region 25 is higher than ordinary temperature, and the heat of the high temperature region 24 is less likely to be released circumferentially. Consequently, luminance saturation is observed, and efficiency of fluorescence emission decreases.

Meanwhile, in the optical element 1 of the first embodiment, the heat, generated on the surface of the phosphor layer 2 irradiated with the excitation light 14, can transfer to a thermal-conductive layer formed on the phosphor layer 2. Hence, compared with the optical element 11, of the comparative example, without a thermal-conductive layer, the optical element 11 of the first embodiment curbs a temperature rise in the high temperature region 24 such that temperature quenching (luminance saturation) is less likely to occur. Consequently, such features make it possible to curb a decrease in efficiency of fluorescence emission and increase a flux of the emitted fluorescence 15.

Phosphor Layer

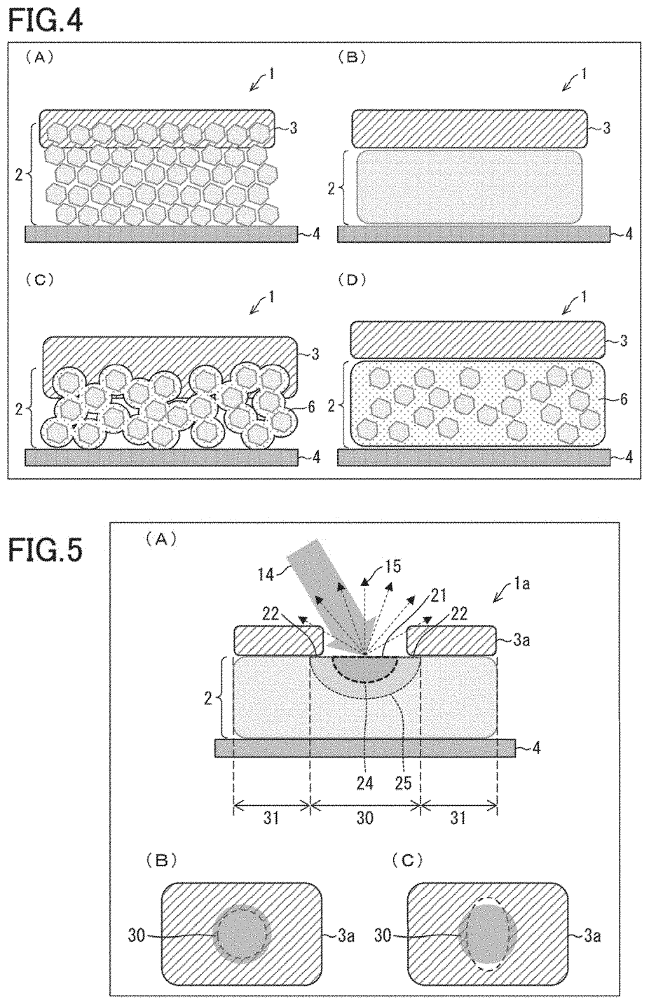

FIG. 4 is a schematic view illustrating exemplary arrangements of layers included in the optical element in the first embodiment of the disclosure.

As illustrated in FIG. 4(A), FIG. 4(C), and FIG. 4(D), the phosphor layer 2 may be a polycrystalline layer containing polycrystalline phosphors. Moreover, as illustrated in FIG. 4(B), the phosphor layer 2 may be a monocrystalline layer containing a monocrystalline phosphor.

As illustrated in FIG. 4(A), a plurality of phosphors may be pressed and molded to form the phosphor layer 2. Moreover, as illustrated in FIG. 4(C), the phosphors may be contained in a binder 6 so that the contained phosphors may serve as the phosphor layer 2. Furthermore, as illustrated in FIG. 4(D), the binder 6 may form a binder layer in which phosphors are dispersed. Such a binder layer may serve as the phosphor layer 2. Examples of the binder include translucent resin and a ceramic material such as alumina. The binder may be the same as, or different from, a material included in the translucent thermal-conductive layer 3. In a preferable embodiment, the translucent thermal-conductive layer 3 is mainly made of a material included in the binder 6. For example, the translucent thermal-conductive layer 3 and the binder 6 may be made of a common material mainly made of alumina.

When irradiated with excitation light, the phosphor layer 2 generates heat therein, depending on the emitted energy. The generated heat causes thermal expansion and contraction to both the phosphor layer 2 and the translucent thermal-conductive layer 3. When the thermal expansion and contraction is repeated, the difference in thermal expansion coefficient develops delamination and cracking on an interface between the phosphor layer 2 and the translucent thermal-conductive layer 3. If the translucent thermal-conductive layer 3 is mainly made of a material included in the binder 6, the difference in thermal expansion coefficient between the translucent thermal-conductive layer 3 and the phosphor layer 2 is small on the interface between the translucent thermal-conductive layer 3 and the phosphor layer 2. Such a feature reduces the risks of the cracking in the interface and the delamination of the translucent thermal-conductive layer 3 from the phosphor layer 2. Hence, the material included in the binder 6 is used as a main ingredient of the translucent thermal-conductive layer 3, making it possible to reduce the risk of damage by thermal stress to the translucent thermal-conductive layer 3 or the phosphor layer 2.

Moreover, if the translucent thermal-conductive layer 3 is mainly made of a material included in the binder 6, the difference in refractive index is small between the translucent thermal-conductive layer 3 and the phosphor layer 2. The small difference in refractive index reduces the risks of reflection loss of the excitation light 14 and reflection loss of the emitted fluorescence on the interface between the translucent thermal-conductive layer 3 and the phosphor layer 2.

The phosphor layer 2 preferably contains the binder 6 higher in thermal conductivity than the phosphor particles. The phosphor layer 2, containing the phosphors and the binder 6 having such a thermal conductivity, is higher in thermal conductivity than a phosphor layer formed of a phosphor alone. For example, when the phosphor layer 2 is formed of a mixture of phosphor particles mainly made of YAG:Ce and the binder 6 mainly made of alumina at a ratio of 6 to 4, the phosphor layer 2 is higher in thermal conductivity than a phosphor layer formed of a phosphor alone mainly made of YAG:Ce. In view of curbing a temperature rise in the phosphor layer 2 irradiated with the excitation light 14, the thermal conductivity of the translucent thermal-conductive layer 3 in another preferable embodiment is preferably higher than or equal to the thermal conductivity of the binder 6.

### Second Embodiment

Described next is an optical element in a second embodiment of the disclosure, with reference to FIG. 5(A) and FIG. 5(B). Note that the features already described above will not be elaborated upon in the embodiments below, and the differences between the first embodiment and other embodiments will be mainly elaborated upon.

FIG. 5(A) and FIG. 5(B) show an optical element 1a in the second embodiment. The illustration (A) is a schematic cross-sectional view, and the illustration (B) is a schematic top view.

The optical element 1a in the second embodiment is different from the optical element 1 in the first embodiment in that the optical element 1a includes a translucent thermal-conductive layer 3a partially covering a region 30 irradiated with excitation light. In this Description, the “region irradiated with excitation light” includes the irradiation center region 21 and the irradiation edge region 22. Furthermore, the “region not irradiated with excitation light” is a region included in a face, of the phosphor layer 2, irradiated with the excitation light, and excluding the irradiation center region 21 and the irradiation edge region 22. That is, the face, of the phosphor layer 2, irradiated with the excitation light includes the region 30 irradiated with the excitation light and a region 31 not irradiated with the excitation light.

The portion surrounded with the dashed line in FIG. 5(B) indicates a region not covered with the translucent thermal-conductive layer 3a. In order to reduce the risk of a decrease in the amount of at least one of the excitation light 14 and the emitted fluorescence 15 passing through the translucent thermal-conductive layer 3a, the translucent thermal-conductive layer 3a is preferably formed on the phosphor layer 2 not to cover the irradiation center region 21.

Modification

FIG. 5(C) is a schematic top view of a modification of the optical element 1a in the second embodiment. The optical element 1a in FIG. 5(C) is different from that in FIG. 5(A) and FIG. (B) in that the region not covered with the translucent thermal-conductive layer 3a (the portion surrounded with the dashed line) includes the region 31 not irradiated with excitation light.

This embodiment may be combined with any given embodiment described above.

### Third Embodiment

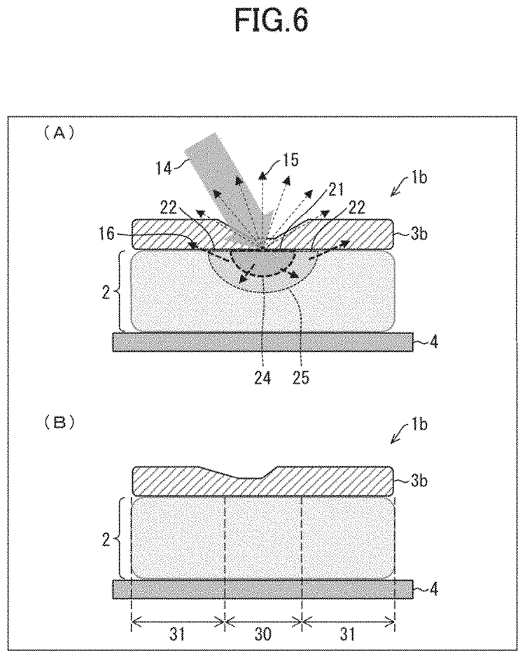

Described next is an optical element in a third embodiment of the disclosure, with reference to FIG. 6. FIG. 6 is a schematic cross-sectional view of an optical element 1b in the third embodiment.

The optical element 1b in the third embodiment is different from the optical element 1 in the first embodiment in that the optical element 1b includes a translucent thermal-conductive layer 3b. Of the translucent thermal-conductive layer 3b, an average thickness covering the region 31 not irradiated with excitation light is greater than an average thickness covering the region 30 irradiated with the excitation light. Such a feature makes it possible to reduce the risk of a decrease in the amount of at least one of the excitation light 14 and the emitted fluorescence 15 passing through the translucent thermal-conductive layer 3b. For example, as illustrated in FIG. 6(A), the thickness may be reduced of the translucent thermal-conductive layer 3b covering the irradiation center region 21. Moreover, as illustrated in FIG. 6(B), the thickness may be reduced of the translucent thermal-conductive layer 3b covering the region 30, taking the irradiation direction into consideration. In view of reducing the risk of a decrease in the amount of at least one of the excitation light 14 and the emitted fluorescence 15 passing through the translucent thermal-conductive layer 3b, the thickness is preferably reduced of the translucent thermal-conductive layer 3b covering the irradiation center region 21.

This embodiment may be combined with any given embodiment described above.

### Fourth Embodiment

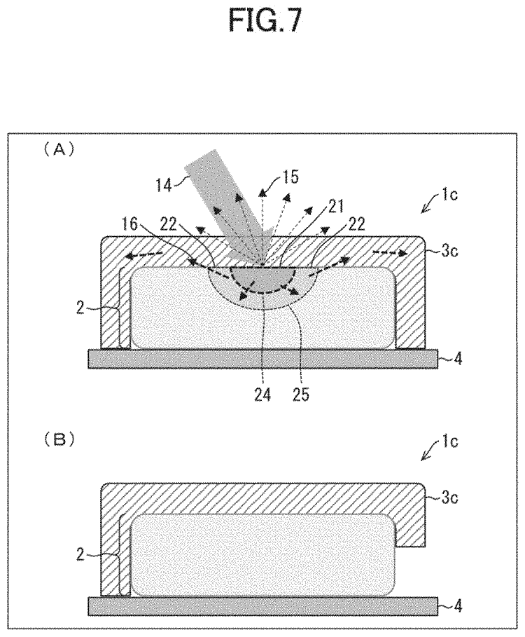

Described next is an optical element in a fourth embodiment of the disclosure, with reference to FIG. 7. FIG. 7 is a schematic cross-sectional view of an optical element 1c in the fourth embodiment.

The optical element 1c in the fourth embodiment is different from the optical element 1 in the first embodiment in that the optical element 1c includes a translucent thermal-conductive layer 3c formed on a side face of the phosphor layer 2. Such a feature increases thermal capacity of the translucent thermal-conductive layer 3c, making it possible to further curb a temperature rise in the high temperature region 24, thereby curbing a decrease in efficiency of fluorescence emission. As illustrated in FIG. 7(A), the translucent thermal-conductive layer 3c may cover all the side faces of the phosphor layer 2. Moreover, as illustrated in FIG. 7(B), the translucent thermal-conductive layer 3c may partially cover a side face of the phosphor layer 2. As illustrated in FIG. 7, in order to enhance an effect of thermal conductivity, the translucent thermal-conductive layer 3c is preferably formed on a side face of the phosphor layer 2 to make contact with the non-translucent thermal-conductive layer 4. A film thickness of the translucent thermal-conductive layer 3c formed on a side face of the phosphor layer may be the same as, or different from, a film thickness of the translucent thermal-conductive layer 3c formed on a face, of the phosphor layer 2, irradiated with the excitation light 14.

This embodiment may be combined with any given embodiment described above.

### Fifth Embodiment

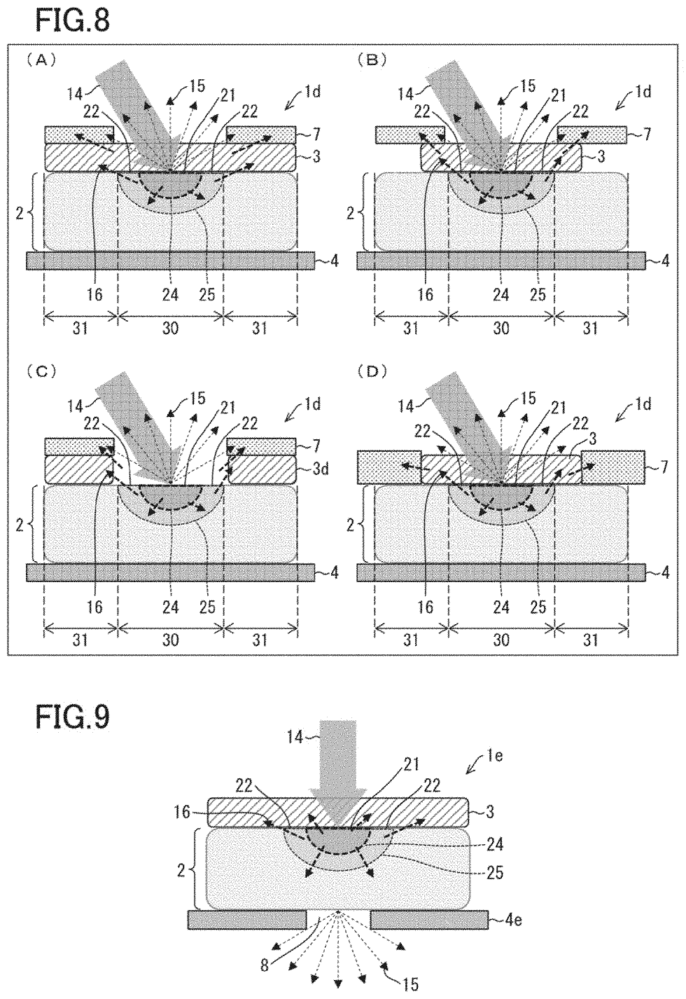

Described next is an optical element in a fifth embodiment of the disclosure, with reference to FIG. 8. FIG. 8 is a schematic cross-sectional view of an optical element 1d in the fifth embodiment.

The optical element 1d in the fifth embodiment is different from the optical element 1 in the first embodiment in that the optical element 1d further includes a thermal-conductive layer 7 formed at least: on a portion of a side face of the translucent thermal-conductive layer 3 (3d); and in a portion of the region 31 not irradiated with excitation light. Such a feature further enhances the effect of thermal conductivity, making it possible to curb a temperature rise in the high temperature region 24, thereby curbing a decrease in efficiency of fluorescence emission.

For example, as illustrated in FIG. 8(A) and FIG. 8(C), the thermal-conductive layer 7 may be formed on the translucent thermal-conductive layer 3 (3d) formed above the region 31 not irradiated with the excitation light. As illustrated in FIG. 8 (A), the translucent thermal-conductive layer 3 may cover the region 30 irradiated with the excitation light and the region 31 not irradiated with the excitation light. As illustrated in FIG. 8 (C), the translucent thermal-conductive layer 3d may cover the region 31 alone not irradiated with the excitation light.

Moreover, as illustrated in FIG. 8 (B), not all the thermal-conductive layer 7 has to be formed on the translucent thermal-conductive layer 3. The thermal-conductive layer 7 may partially be formed on the translucent thermal-conductive layer 3 formed above the region 31 not irradiated with the excitation light.

Furthermore, as illustrated in FIG. 8(D), the thermal-conductive layer 7 may be formed to make contact with a side face of the translucent thermal-conductive layer 3. Not all the thermal-conductive layer 7 has to be formed on the phosphor layer 2. The thermal-conductive layer 7 may partially be formed on the phosphor layer 2 and may make contact with the side face of the translucent thermal-conductive layer 3.

In order to enhance the effect of thermal conductivity, the thermal-conductive layer 7 preferably has a thermal conductivity higher than, or equal to, the thermal conductivity of the translucent thermal-conductive layer 3.

The thermal-conductive layer 7 may be either translucent or non-translucent. Metal is an example of a material that the thermal-conductive layer 7 is made of.

This embodiment may be combined with any given embodiment described above.

### Sixth Embodiment

Described next is an optical element in a sixth embodiment of the disclosure, with reference to FIG. 9. FIG. 9 is a schematic cross-sectional view of an optical element 1e in the sixth embodiment.

The optical element 1e in the sixth embodiment is different from the optical element 1 in the first embodiment in that the optical element 1e includes a non-translucent thermal-conductive layer 4e including a fluorescence obtainment hole 8. Thanks to such a feature, the optical element 1e can be used as a transmissive optical element. The fluorescence obtainment hole 8 may be formed in any given size, depending on the usage of the optical element.

Modification

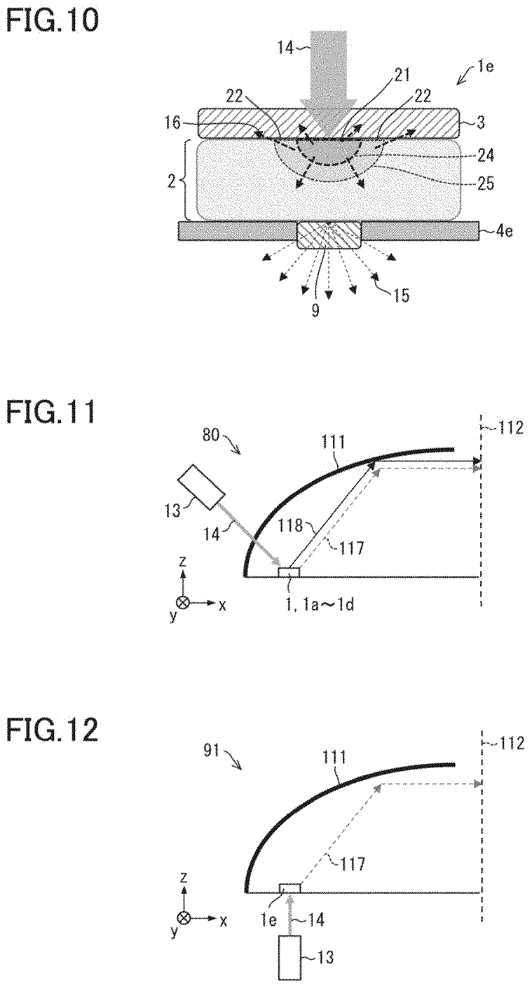

The optical element 1e in FIG. 10 is different from the optical element 1e in FIG. 9 in that, in the former, the fluorescence obtainment hole 8 is provided with a fluorescence obtainment member 9. The fluorescence obtainment member 9 makes it possible to obtain the emitted fluorescence 15 more efficiently. An example of the fluorescence obtainment member 9 includes a translucent thermal-conductive layer.

This embodiment may be combined with any given embodiment described above.

### Seventh Embodiment

FIG. 11 is a schematic view of a vehicle headlight in a seventh embodiment of the disclosure. A vehicle headlight 80 includes: any one of the optical elements 1 and 1a to 1d in the first to fifth embodiments; a light source device 13; and a reflector 111. The vehicle headlight 80 according to the seventh embodiment is a reflective vehicle headlight.

The light source 13 emits excitation light to the optical elements 1 and 1a to 1d. The light source 13 is preferably a blue-laser light source emitting the excitation light 14 having a wavelength to excite the phosphor layer of the optical elements 1 and 1a to 1d.

The reflector 111 includes a reflective face reflecting the fluorescence, exiting from the optical elements 1 and 1a to 1d, to exit parallel in a certain direction. The reflector 111 preferably includes a semi-parabolic mirror. Preferably, the reflector 111 is a semi-parabolic face formed of one of halves into which a parabolic face is vertically divided in parallel with an xy plane, and the interior of the semi-parabolic face is a mirror. Moreover, the reflector 111 includes a transparent hole allowing the excitation light 14 to pass therethrough, so that the optical elements 1 and 1a to 1d are irradiated with the excitation light 14.

The optical elements 1 and 1a to 1d are excited with the excitation light 14 colored blue, and emit fluorescence 117 having a long wavelength range (a yellow wavelength) in visible light. Furthermore, the excitation light 14 hits the optical elements 1 and 1a to 1d to be diffused reflected light 118. The optical elements 1 and 1a to 1d are positioned in a focus of the parabolic face. Because the optical elements 1 and 1a to 1d are positioned in the focus of the parabolic mirror, the fluorescence 117 emitted from the optical elements 1 and 1a to 1d and the diffused reflected light 118 reflect on the reflector 111 and travel uniformly straight to an exit face 112. The emitted fluorescence 117 and the diffused reflected light 118 blend together to be white light, and the white light exits parallel from the exit face 112.

### Eighth Embodiment

FIG. 12 is a schematic view of a vehicle headlight according to an eighth embodiment of the disclosure. A vehicle headlight 91 includes: the optical element 1e in the sixth embodiment; the light source device 13; and the reflector 111. The vehicle headlight 91 according to the eighth embodiment is a transmissive vehicle headlight.

The optical elements 1e is excited with the excitation light 14 colored blue, and emits the fluorescence 117 having a long wavelength range (a yellow wavelength) in visible light. The optical elements 1e is positioned in a focus of the parabolic face. The light source 13 emits incident light from the translucent thermal-conductive layer 3 of the optical element 1e. The reflector 111 includes a reflective face reflecting the fluorescence, exiting from the non-translucent thermal-conductive layer 4 of the optical element 1e, to exit parallel in a certain direction.

### Ninth Embodiment

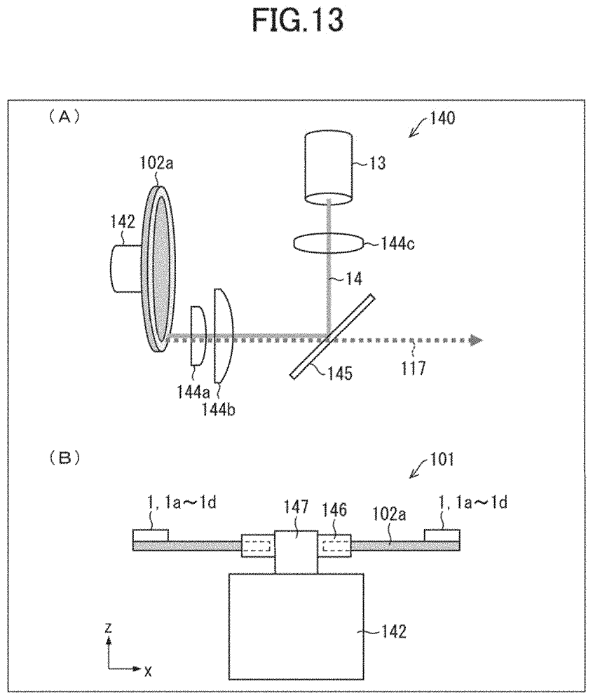

FIG. 13 is a schematic view illustrating a light source device according to a ninth embodiment of the disclosure. FIG. 13(A) is a schematic view of the light source device in the ninth embodiment. FIG. 13(B) is a side view (an xy plane) illustrating a configuration of a light source module of the light source device in the ninth embodiment.

A light source device 140 includes: the light source 13; a fluorescent wheel 102a; and a driver 142.

The light source device 140 is preferably used for, for example, a projector. In the light source device 140, the light source 13 is preferably a blue-laser light source emitting the excitation light 14 having a wavelength to excite the phosphor layer of the optical elements 1 and 1a to 1d. Used in a preferable embodiment is a blue-laser diode exciting such phosphors as YAG and lutetium aluminium garnet, Lu₃Al₅O₁₂:Ce (LuAG). The excitation light 14, with which the phosphor layer of the optical elements 1 and 1a to 1d is irradiated, can pass through lenses 144a, 144b, and 144c in the optical path. A mirror 145 may be disposed in the optical path of the excitation light 14. Preferably, the mirror 145 is a dichroic mirror.

The fluorescent wheel 102a is fastened with a wheel fastener 146 to a rotation shaft 147 of the driver 142. Preferably, the driver 142 is a motor. The fluorescent wheel 102a is fastened with the wheel fastener 146 to the rotation shaft 147 that is a rotation shaft of the motor. The fluorescent wheel 102a rotates along with the rotation of the motor. The fluorescent wheel 102a has at least a circumferential portion through which the excitation light 14 emitted from the light source 13 passes. The circumferential portion is provided with any one of the optical elements 1 and 1a to 1d in the first to fifth embodiments.

The optical elements 1 and 1a to 1d, provided to an edge on a surface of the fluorescent wheel 102a, receive the excitation light 14 and emit the fluorescence 117. The fluorescence 117 exits through the mirror 145. The optical elements 1 and 1a to 1d, rotating along with the rotation of the fluorescent wheel 102a, always rotate and emit the fluorescence 117.

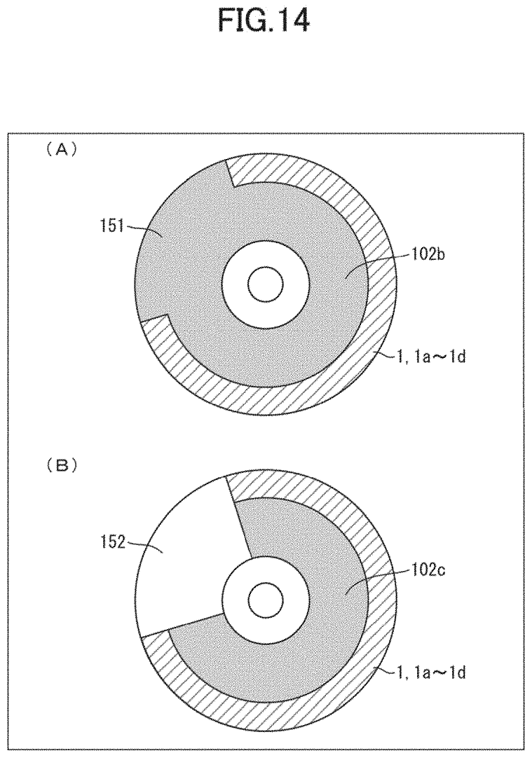

FIG. 14 illustrates a fluorescent wheel of the light source device in the ninth embodiment. FIG. 14(A) illustrates a fluorescent wheel 102b having a plurality of segments partially serving as a reflector 151. The optical elements 1 and 1a to 1d are provided to a circumferential portion of a surface of the fluorescent wheel 102b. Preferably, the optical elements 1 and 1a to 1d are concentrically provided on the wheel.

FIG. 14(B) illustrates a fluorescent wheel 102c having a plurality of segments partially serving as a transmissive portion 152. The optical element 1, and 1a to 1d is provided to a circumferential portion of a surface of the fluorescent wheel 102c. Preferably, the optical element 1, and 1a to 1d is concentrically provided on the wheel. In a preferable embodiment, the transmissive portion 152 is made of glass. Such a segment configuration allows a single fluorescent wheel to guide a plurality of light rays having different wavelength bands.

When the light is excited while the phosphor is low in external quantum yield, the emitted fluorescence is weak with respect to the excitation light, causing a problem of a poor balance between colors. In order to avoid such a problem, adjustments are made to attenuate the excitation light with a filter, and to reduce output by time division. However, such adjustments reduce brightness, and are not preferable. In order to solve such problems, the fluorescent wheels 102b and 102c are circumferentially divided into a plurality of segments, and the optical elements 1 and 1a to 1d are separately applied to each of the segments. Such a feature makes it possible to maintain the external quantum yield at a high level. Consequently, various colors can be created while the brightness is maintained.

### Tenth Embodiment

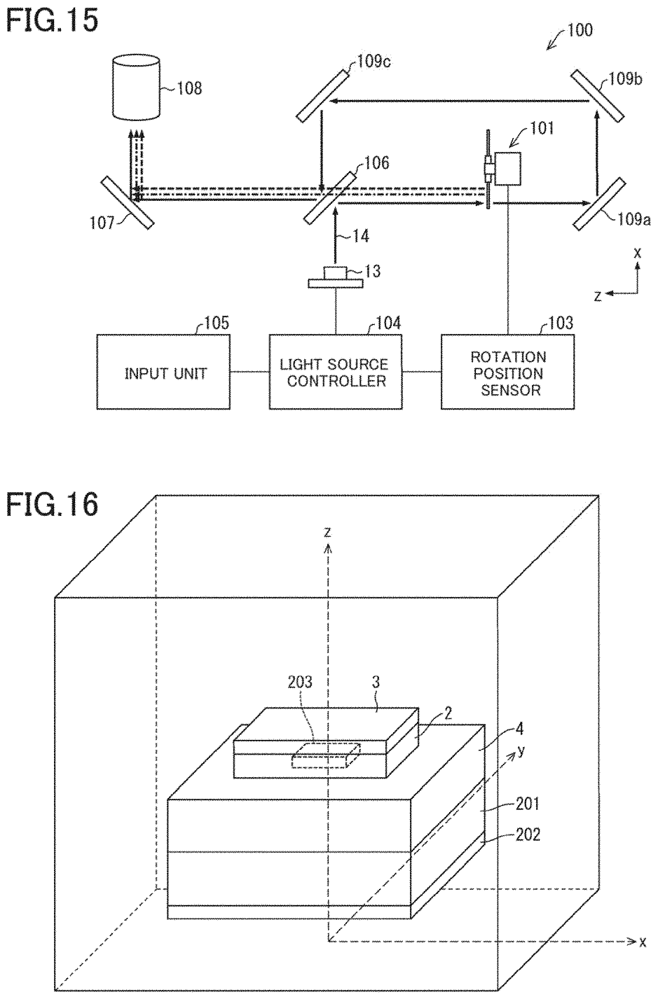

FIG. 15 is a schematic view of a projection device in a tenth embodiment of the disclosure.

A projection device (a projector) 100 includes: a light source device (a light source module) 101; a display element 107; a light source optical system 106; and a projector optical system 108. The light source optical system 106 guides light from the light source device 101 to the display element 107. The projector optical system 108 projects projection light from the display element 107 on a projection target such as a screen.

When the transmissive portion 152 is provided to a portion of the segments of the fluorescent wheel in the light source device 101 (see FIG. 14(B)), the excitation light 14 emitted in blue passes through the fluorescent wheel 102 via the transmissive portion 152. The blue light passing through the fluorescent wheel 102c travels through mirrors 109a to 109c in the optical path. After that, the blue light is reflected on the light source optical system 106 and guided to the display element 107. The fluorescence, generated of the excitation light 14 emitted to the phosphor layer of the optical elements 1 and 1a to 1d provided to a portion of the segments of the fluorescent wheel, can pass the light source optical system 106 in the optical path. Preferably, the light source optical system 106 is a dichroic mirror. The preferable dichroic mirror can reflect blue light entering at an angle of 45°, and pass yellow, red, and green light other than blue light.

More specifically, when a dichroic mirror having the above optical property is adopted as the light source optical system 106, blue light generated of the excitation light 14 entering the dichroic mirror is reflected and directed to the fluorescence wheel 102c. The rotation of the fluorescent wheel 102c is timed to allow the blue light to pass through the fluorescent wheel 102c via the transmissive portion 152. The rotation of the fluorescent wheel 102a is timed to allow the excitation light 14 to be emitted to a segment other than the transmissive portion 152. The excitation light 14 is emitted to the optical elements 1 and 1a to 1d, and the optical elements 1 and 1a to 1d emit fluorescence. The optical elements 1 and 1a to 1d are applied to each of the segments, making it possible to change the colors of the fluorescence emitted from the segments. For example, the optical elements 1 and 1a to 1d having different fluorescent materials are assigned to each of the segments, making it possible to emit from the fluorescence wheel 102a fluorescence having a wavelength band in yellow, red, or green. The fluorescence emitted in yellow, red, and green enters the display element 107 through the dichroic mirror. The blue light passing through the transmissive portion 152 enters the dichroic mirror again through the mirrors 109a to 109c. After that, the blue light is reflected again in the dichroic mirror and enters the display element 107.

In a preferable embodiment, the display element 107 is a digital mirror device (DMD). Preferably, the projector optical system 108 is a combination of projector lenses.

### SUMMARY

An optical element according to a first aspect of the disclosure includes: a phosphor layer excited by excitation light emitted from a light source, and emitting fluorescence; a translucent thermal-conductive layer formed on a face, of the phosphor layer, irradiated with the excitation light; and a non-translucent thermal-conductive layer formed on a face, of the phosphor layer, across from the face irradiated with the excitation light. The translucent thermal-conductive layer has a thermal conductivity higher than, or equal to, a thermal conductivity of the phosphor layer.

Thanks to the above features, the heat is released from the non-translucent thermal-conductive layer, making it possible to curb a rise in temperature of the phosphor layer. Moreover, the translucent thermal-conductive layer has a thermal conductivity higher than a thermal conductivity of the phosphor layer, making it possible to curb a rise in temperature of the phosphor layer irradiated with the excitation light.

In the optical element, of the first aspect, according to a second aspect of the disclosure, the phosphor layer may include at least: a binder; and phosphor particles. The translucent thermal-conductive layer may be mainly made of a material included in the binder.

Thanks to the above feature, the phosphor layer is higher in thermal conductivity than a phosphor layer formed of a phosphor alone, making it possible to curb a rise in temperature of the phosphor layer.

In the optical element, of the first aspect or the second aspect, according to a third aspect of the disclosure, the translucent thermal-conductive layer may partially cover a region irradiated with the excitation light.

Such a feature makes it possible to curb a decrease in the amount of at least one of the excitation light and the emitted fluorescence passing through the translucent thermal-conductive layer.

In the optical element, of any one of the first to third aspects, according to a fourth embodiment of the disclosure, of the translucent thermal-conductive layer, an average thickness of a region not irradiated with the excitation light may be greater than an average thickness of a region irradiated with the excitation light.

Such a feature makes it possible to reduce the risk of a decrease in the amount of at least one of the excitation light and emitted fluorescence passing through the translucent thermal-conductive layer.

In the optical element, of any one of the first to fourth aspects, according to a fifth aspect of the disclosure, the translucent thermal-conductive layer may further be formed on a side face of the phosphor layer.

The above feature increases the amount of the thermal-conductive layer covering the phosphor layer, further enhancing the effect of thermal conductivity and making it possible to curb a rise in temperature of the phosphor layer.

The optical element, of any one of the first to fifth aspects, according to a sixth aspect of the disclosure may further include a thermal-conductive layer formed at least: on a portion of a side face of the translucent thermal-conductive layer; and in a portion of a region not irradiated with the excitation light.

The above feature further enhances the effect of thermal conductivity, making it possible to curb a rise in temperature of the phosphor layer.

In the optical element, of any one of the first to sixth aspects, according to a seventh aspect of the disclosure, the non-translucent thermal-conductive layer may include a fluorescence obtainment hole for obtaining the fluorescence.

Thanks to such a feature, the optical element according to an aspect of the disclosure can be used as a transmissive optical element.

In the optical element, of the seventh aspect, according to an eight aspect of the disclosure, the fluorescence obtainment hole may be provided with a fluorescence obtainment member.

Thanks to such a feature, the optical element according to an aspect of the disclosure can be used as a transmissive optical element.

A vehicle headlight according to a ninth aspect of the disclosure includes: the optical element according to any one of the first to sixth aspects; a light source emitting excitation light to the optical element; and a reflector including a reflective face reflecting fluorescence exiting from the optical element. The reflective face of the reflector reflects the fluorescence, exiting from the optical element, to exit parallel in a certain direction.

Thanks to the above features, the optical element according to an aspect of the disclosure can curb a decrease in fluorescence emission efficiency of a reflective vehicle headlight.

A vehicle headlight according to a tenth aspect of the disclosure includes: the optical element according to the seventh aspect or the eighth aspect; a light source emitting excitation light to the optical element; and a reflector including a reflective face reflecting fluorescence exiting from the optical element. The reflective face of the reflector reflects the fluorescence, exiting from the non-translucent thermal-conductive layer, to exit parallel in a certain direction.

Thanks to the above features, the optical element according to an aspect of the disclosure can curb a decrease in fluorescence emission efficiency of a transmissive vehicle headlight.

A light source device according to an eleventh aspect of the disclosure includes: a light source emitting excitation light; a fluorescent wheel having at least a circumferential portion through which the excitation light emitted from the light source passes, the circumferential portion being provided with the optical element according to any one of the first to eighth aspects; and a driver rotating the fluorescent wheel.

Thanks to the above features, the optical element according to an aspect of the disclosure can curb a decrease in fluorescence emission efficiency of the light source device. Moreover, the features can decrease the rotation speed of a fluorescent wheel in the light source device. Consequently, the features can curb power consumption of, and noise generated in, the driver required for rotation of the fluorescent wheel, and reduce heat generated by the driver.

A projection device according to a twelfth aspect of the disclosure includes: the light source device according to the eleventh aspect; a display element; a light source optical system guiding light from the light source device to the display element; and a projector optical system projecting projection light from the display element on a projection target.

Thanks to the above features, the optical element according to an aspect of the disclosure can curb a decrease in fluorescence emission efficiency of the projection device.

The disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the disclosure. Moreover, the technical aspects disclosed in each embodiment may be combined to achieve a new technical feature.

### EXAMPLES

### [Evaluation Example 1] Relationship Between a Film Thickness of the Translucent Thermal-Conductive Layer 3 and a Temperature of the Irradiation Center Region 21

A simulation analysis was conducted on a computer to find out a relationship between a film thickness of the translucent thermal-conductive layer 3 and a temperature of the irradiation center region 21 in the optical element 1 according to an aspect of the disclosure.

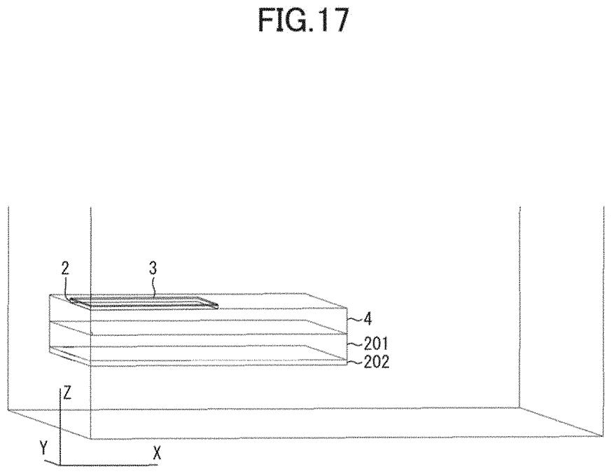

FIGS. 16 and 17 are schematic views of a stacking model used in the simulation of the examples. In FIG. 16, a plane along the largest plane of a heat generator 203 is defined as an xy plane, and the orthogonal coordinate system is defined so that the origin of the heat generator 203 on the xy plane has coordinates of x=0 and y=0. The direction orthogonal to the x-axis and y-axis directions is defined as the z-axis direction. FIG. 17 shows the stacking model illustrated in FIG. 16 and used in the simulation of the examples, cut into one fourth (corresponding to the first quadrant on the xy plane) at the coordinates of x=0 and y=0. As illustrated in FIGS. 16 and 17, the model included a constant temperature plate 202 (10 mm×10 mm) to maintain a constant temperature of 25° C., a thermal conductive sheet 201 (10 mm×10 mm×0.5 mm), a non-translucent thermal-conductive layer 4 (10 mm×10 mm×0.5 mm), a phosphor layer 2 (5 mm×5 mm×0.025 mm), and a translucent thermal-conductive layer 3 (5 mm×5 mm) stacked in the stated order along the z-axis. The staking model was placed in an atmosphere of 25° C. The non-translucent thermal-conductive layer 4 was made of aluminium.

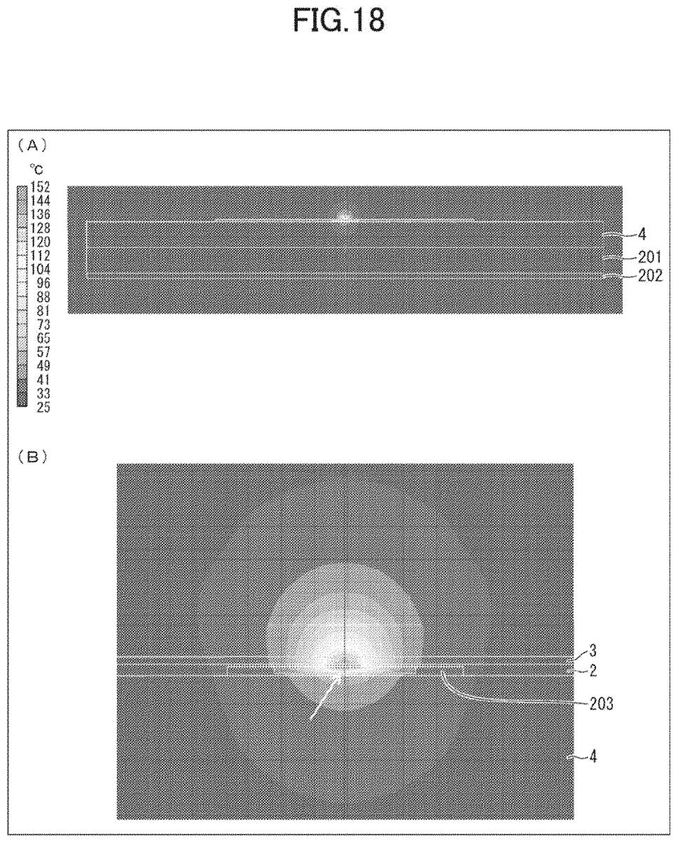

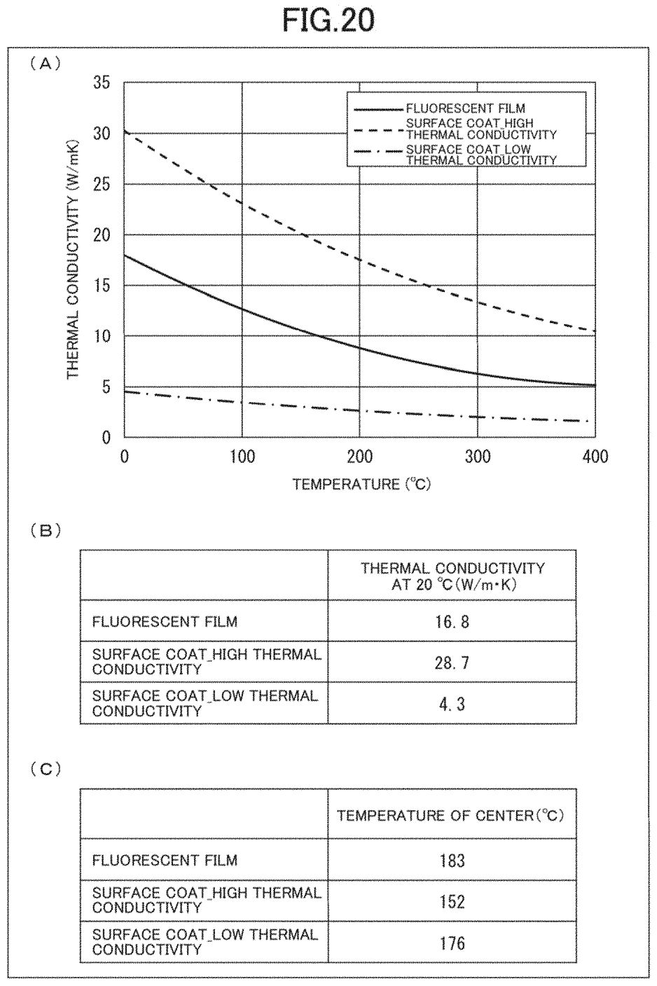

The heat generator 203 (0.5 mm×0.5 mm×0.02 mm) was placed inside the phosphor layer 2. The amount of the heat generated by the heat generator 203 was set in four stages so that the origin (x=0 and y=0) would exhibit the largest amount of heat. The thermal conductivity of the translucent thermal-conductive layer 3 included thermal dependency illustrated in FIG. 20(A) to be described later. Temperatures of a region (the arrow in FIG. 18, corresponding to the irradiation center region 21) reaching the highest temperature in the phosphor layer 2 were compared when a thickness of the translucent thermal-conductive layer 3 was set to 0 μm, 15 μm, 25 μm, 50 μm, and 100 μm. FIG. 18(A) illustrates a distribution of the temperature in the phosphor layer 2. FIG. 18(B) is an enlarged view of the distribution.

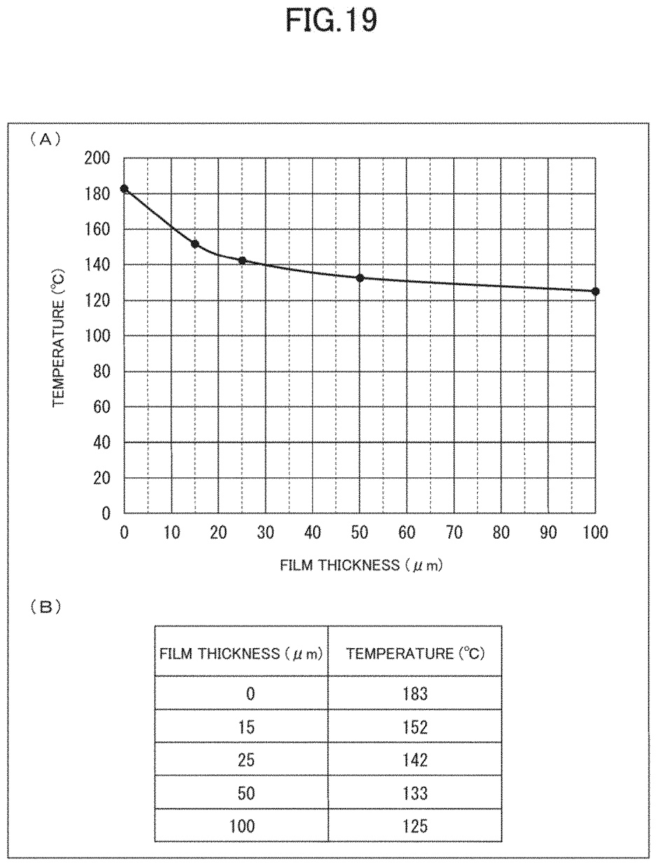

FIG. 19 shows a measured temperature calculated by the simulation. In FIG. 19, the “film thickness” indicates a film thickness of the translucent thermal-conductive layer 3, and the “temperature” indicates a temperature of the region (the arrow in FIG. 18, corresponding to the irradiation center region 21) reaching the highest temperature in the phosphor layer 2.

FIG. 19 shows that, when the film thickness of the translucent thermal-conductive layer 3 is greater, the temperature is lower in the region (corresponding to the irradiation center region 21) reaching the highest temperature in the phosphor layer 2. Such a finding shows that a decrease in light emission efficiency of the optical element 1 can be curbed.

### [Evaluation Example 2] Relationship Between Thermal Conductivities of the Translucent Thermal-Conductive Layer 3 and the Phosphor Layer 2 and a Temperature of the Irradiation Center Region 21

Similar to Evaluation Example 1, a simulation analysis was conducted on a computer to find out a relationship between thermal conductivities of the translucent thermal-conductive layer 3 and the phosphor layer 2 and a temperature of the irradiation center region 21 in the optical element 1 according to an aspect of the disclosure. Temperatures of the region (the arrow in FIG. 18, corresponding to the irradiation center region 21) reaching the highest temperature in the phosphor layer 2 were compared when the translucent thermal-conductive layer 3 was higher in thermal conductivity than the phosphor layer 2 and when the translucent thermal-conductive layer 3 was lower in thermal conductivity than the phosphor layer 2. The non-translucent thermal-conductive layer 3 had a film thickness of 15 μm. For a reference, a simulation was also conducted for the region reaching the highest temperature in the phosphor layer 2 without the translucent thermal-conductive layer 3.

FIG. 20 shows a measured temperature calculated by the simulation. In FIG. 20, the “fluorescent film” indicates a result of the simulation without the translucent thermal-conductive layer 3. The “surface coat_high thermal conductivity” indicates a result of the simulation conducted when the translucent thermal-conductive layer 3 was higher in thermal conductivity than the phosphor layer 2. The “surface coat_low thermal conductivity” indicates a result of the simulation conducted when the translucent thermal-conductive layer 3 was lower in thermal conductivity than the phosphor layer 2.

FIG. 20 shows that, when the translucent thermal-conductive layer 3 was higher in thermal conductivity than the phosphor layer 2, the temperature was lower in the region (corresponding to the irradiation center region 21) reaching the highest temperature in the phosphor layer 2.

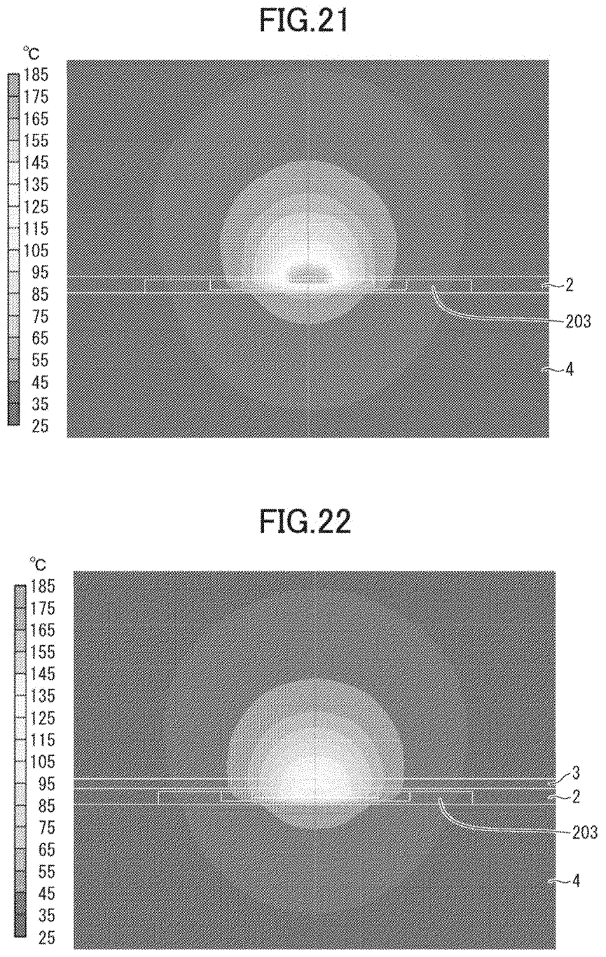

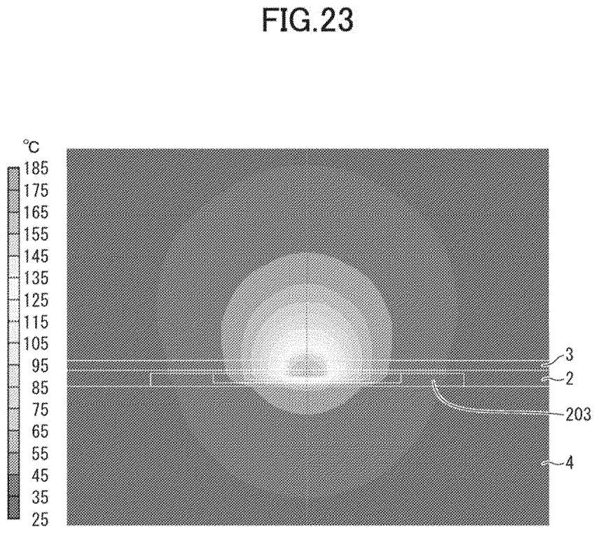

FIG. 21 shows a distribution of the temperature in the phosphor layer, obtained by a simulation without the translucent thermal-conductive layer 3 (fluorescent film) in Evaluation Example 2. FIG. 22 shows a distribution of the temperature in the phosphor layer 2, obtained by a simulation conducted when the translucent thermal-conductive layer 3 was higher in thermal conductivity than the phosphor layer 2 (surface coat_high thermal conductivity) in Evaluation Example 2. FIG. 23 shows a distribution of the temperature in the phosphor layer 2, obtained by a simulation conducted when the translucent thermal-conductive layer 3 was lower in thermal conductivity than the phosphor layer 2 (surface coat_low thermal conductivity) in Evaluation Example 2.

FIGS. 21 to 23 show that, without the translucent thermal-conductive layer 3, the temperature of the irradiation center region 21 inevitably rose (see FIG. 21). A comparison between FIGS. 22 and 23 shows that the rise in the temperature of the irradiation center region 21 was to be curbed when the translucent thermal-conductive layer 3 was higher in thermal conductivity than the phosphor layer 2.

1-12. (canceled)

13. An optical element, comprising:
a phosphor layer excited by excitation light emitted from a light source, and configured to emit fluorescence;
a translucent thermal-conductive layer formed in direct contact with on a face of the phosphor layer that is irradiated with the excitation light; and
a non-translucent thermal-conductive layer formed on a face of the phosphor layer that is across from the face irradiated with the excitation light,
the translucent thermal-conductive layer having a thermal conductivity higher than, or equal to, a thermal conductivity of the phosphor layer, and
the phosphor layer including at least: a binder; and phosphor particles.

14. The optical element according to claim 13, wherein
the translucent thermal-conductive layer is mainly made of a material included in the binder.

15. The optical element according to claim 13, wherein
the translucent thermal-conductive layer covers a part of a region irradiated with the excitation light.

16. The optical element according to claim 13, wherein
the translucent thermal-conductive layer has a region that is exposed to be irradiated with the excitation light in a surface opposite to a surface facing the phosphor layer of the translucent thermal-conductive layer.

17. The optical element according to claim 13, wherein
the translucent thermal-conductive layer exposes a part of a region of the phosphor layer irradiated with the excitation light, and
the translucent thermal-conductive layer covers a region except the part of the region of the phosphor layer irradiated with the excitation light.

18. The optical element according to claim 17, wherein
the part of the region is a center region of the region of the phosphor layer irradiated with the excitation light.

19. The optical element according to claim 13, wherein
in the translucent thermal-conductive layer, an average thickness of a region not irradiated with the excitation light is greater than an average thickness of a region irradiated with the excitation light.

20. The optical element according to claim 13, wherein the translucent thermal-conductive layer is further formed on a side face of the phosphor layer.

21. The optical element according to claim 13, further comprising
a thermal-conductive layer formed at least: on a portion of a side face of the translucent thermal-conductive layer; and in a portion of a region not irradiated with the excitation light.

22. The optical element according to claim 13, wherein
the non-translucent thermal-conductive layer includes a fluorescence obtainment hole for obtaining the fluorescence.

23. The optical element according to claim 22, wherein
the fluorescence obtainment hole is provided with a fluorescence obtainment member.

24. A vehicle headlight, comprising:
the optical element according to claim 13;
a light source configured to emit excitation light to the optical element; and
a reflector including a reflective face reflecting fluorescence exiting from the optical element,
the reflective face of the reflector reflecting the fluorescence, exiting from the optical element, to exit parallel in a certain direction.

25. A vehicle headlight, comprising:
the optical element according to claim 22;
a light source configured to emit excitation light to the optical element; and
a reflector including a reflective face reflecting fluorescence exiting from the optical element,
the light source emitting incident light from the translucent thermal-conductive layer, and
the reflective face of the reflector reflecting the fluorescence, exiting from the non-translucent thermal-conductive layer, to exit parallel in a certain direction.

26. A light source device, comprising:
a light source configured to emit excitation light;
a fluorescent wheel having at least a circumferential portion through which the excitation light emitted from the light source passes, the circumferential portion being provided with the optical element according to claim 13; and
a driver configured to rotate the fluorescent wheel.

27. A projection device, comprising:
the light source device according to claim 26;
a display element;
a light source optical system configured to guide light from the light source device to the display element; and
a projector optical system configured to project projection light from the display element on a projection target.
